(19) United States
(12) Patent Application Publication
(10) Pub. No.: US 2026/0287176 A1
(43) Pub. Date: Sep. 24, 2026

(54) COMBUSTION SYSTEM

(71) Applicant: IHI Corporation, Tokyo (JP)

(72) Inventors: Shintaro ITO, Tokyo (JP); Toshiro FUJIMORI, Tokyo (JP)

(73) Assignee: IHI Corporation, Tokyo (JP)

(21) Appl. No.: 19/671,507

(22) Filed: May 8, 2026

Related U.S. Application Data
(63) Continuation of application No. PCT/JP2024/037737, filed on Oct. 23, 2024.

(30) Foreign Application Priority Data
Nov. 15, 2023 (JP) 2023-194123

(51) Int. Cl. F23R 3/28; F23K 5/20

(52) U.S. Cl. CPC F23R 3/28; F23K 5/20; F23K 2300/204; F23R 2900/00002

(57) ABSTRACT

Provided is a combustion system, including: an ammonia tank in which ammonia is allowed to be stored in a liquid state; a combustor including: a combustion chamber; and an injector facing the combustion chamber, the injector being connected to the ammonia tank via a flow passage for the ammonia, the ammonia being allowed to be supplied in a liquid state to the injector; a temperature controller that adjusts a temperature of the ammonia to be supplied to the injector; and a controller that controls the temperature controller based on information regarding a pressure of the ammonia in the injector such that the temperature of the ammonia to be supplied to the injector becomes equal to or lower than a saturation temperature of the ammonia in the injector.

### CROSS REFERENCE TO RELATED APPLICATIONS

This application is a continuation application of International Application No. PCT/JP2024/037737, filed on Oct. 23, 2024, which claims priority to Japanese Patent Application No. 2023-194123, filed on Nov. 15, 2023, the entire contents of which are incorporated by reference herein.

### BACKGROUND ART

### Technical Field

The present disclosure relates to a combustion system. This application claims the benefit of priority to Japanese Patent Application No. 2023-194123 filed on Nov. 15, 2023, and contents thereof are incorporated herein.

### Related Art

As a combustion system for combusting fuel in a combustor, a gas turbine system or the like has been used. In the combustion system such as the gas turbine system, for example, ammonia may be used as fuel, as disclosed in Patent Literature 1. With the use of ammonia as fuel, emission of carbon dioxide is suppressed.

### Citation List

### Patent Literature

Patent Literature 1: JP 2016-191507 A

### SUMMARY

### Technical Problem

As the combustion system, there has been known a system that supplies liquid ammonia to a combustion chamber without vaporizing the liquid ammonia. With such a combustion system, various advantages can be obtained, such as a reduction in equipment cost due to omission of a vaporizer. In addition, in such a combustion system, there has been desired a new proposal for improving efficiency while preventing vaporization of ammonia.

The present disclosure has an object to provide a combustion system capable of improving efficiency of a combustion system.

### Solution to Problem

In order to achieve the above-mentioned object, according to the present disclosure, there is provided a combustion system, including: an ammonia tank in which ammonia is allowed to be stored in a liquid state; a combustor including: a combustion chamber; and an injector facing the combustion chamber, the injector being connected to the ammonia tank via a flow passage for the ammonia, the ammonia being allowed to be supplied in a liquid state to the injector; a temperature controller that adjusts a temperature of the ammonia to be supplied to the injector; and a controller that controls the temperature controller based on information regarding a pressure of the ammonia in the injector such that the temperature of the ammonia to be supplied to the injector becomes equal to or lower than a saturation temperature of the ammonia in the injector.

The flow passage may include a first flow passage and a second flow passage that join at a joining portion on an upstream side of the injector, a temperature of the ammonia flowing into the joining portion from the first flow passage and a temperature of the ammonia flowing into the joining portion from the second flow passage may be different from each other, and the temperature controller may include a flow ratio controller that adjusts a flow ratio that is a ratio between a flow rate of the ammonia flowing into the joining portion from the first flow passage and a flow rate of the ammonia flowing into the joining portion from the second flow passage.

The temperature controller may include a preheater that preheats the ammonia flowing through one of the first flow passage or the second flow passage.

The temperature controller may include: a first preheater that preheats the ammonia flowing through the first flow passage; and a second preheater that preheats the ammonia flowing through the second flow passage.

The flow passage may be free of part that joins on an upstream side of the injector, and the temperature controller may include a preheater that preheats the ammonia flowing through the flow passage.

The information may include a parameter that affects the pressure, and the controller may use a map representing a correspondence relationship between the parameter and the saturation temperature to specify the saturation temperature based on the parameter, and may control the temperature controller based on a specification result of the saturation temperature.

The information may include a parameter that affects the pressure, and the controller may use a map representing a correspondence relationship between the parameter and a control target of the temperature controller to specify the control target based on the parameter, and may control the temperature controller based on a specification result of the control target.

The information may include a parameter that affects the pressure, and the controller may calculate the pressure based on the parameter, and may control the temperature controller based on a calculation result of the pressure.

The information may include a measurement value of the pressure, and the controller may control the temperature controller based on the measurement value.

### Effects

According to the present disclosure, efficiency of the combustion system can be improved.

### BRIEF DESCRIPTION OF DRAWINGS

FIG. 1 is a schematic view for illustrating a configuration of a combustion system according to an embodiment of the present disclosure.

FIG. 2 is a flowchart for illustrating a first example of a flow of processing performed by a controller in the embodiment of the present disclosure.

FIG. 3 is a flowchart for illustrating a second example of a flow of processing performed by the controller in the embodiment of the present disclosure.

FIG. 4 is a flowchart for illustrating a third example of a flow of processing performed by the controller in the embodiment of the present disclosure.

FIG. 5 is a flowchart for illustrating a fourth example of a flow of processing performed by the controller in the embodiment of the present disclosure.

FIG. 6 is a schematic view for illustrating a configuration of a combustion system according to a first modification example.

FIG. 7 is a schematic view for illustrating a configuration of a combustion system according to a second modification example.

FIG. 8 is a schematic view for illustrating a configuration of a combustion system according to a third modification example.

### DESCRIPTION OF EMBODIMENTS

Now, with reference to the attached drawings, an embodiment of the present disclosure is described. The dimensions, materials, and other specific numerical values represented in the embodiment are merely examples used for facilitating the understanding of the disclosure, and do not limit the present disclosure unless otherwise particularly noted. Elements having substantially the same functions and configurations herein and in the drawings are denoted by the same reference symbols to omit redundant description thereof. Further, illustration of elements with no direct relationship to the present disclosure is omitted.

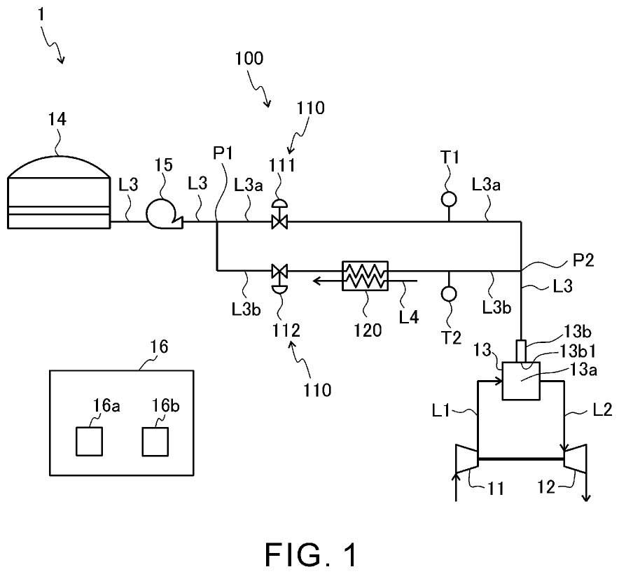

FIG. 1 is a schematic view for illustrating a configuration of a combustion system 1 according to this embodiment. The combustion system 1 is a gas turbine system that obtains motive power by a combustion gas. As illustrated in FIG. 1, the combustion system 1 includes a compressor 11, a turbine 12, a combustor 13, an ammonia tank 14, a pump 15, a controller 16, and a temperature controller 100.

The compressor 11 and the turbine 12 rotate integrally. The compressor 11 and the turbine 12 are coupled to each other through intermediation of a shaft.

The compressor 11 is provided in an intake flow passage L1 connected to the combustor 13. Air to be supplied to the combustor 13 flows through the intake flow passage L1. An intake port (not shown) is formed at an upstream-side end portion of the intake flow passage L1. The intake port allows air to be introduced from an outside. The air introduced through the intake port passes through the compressor 11 and is sent to the combustor 13. The compressor 11 compresses the air and discharges the compressed air to a downstream side.

The turbine 12 is provided in an exhaust flow passage L2 connected to the combustor 13. An exhaust gas discharged from the combustor 13 flows through the exhaust flow passage L2. The exhaust gas discharged from the combustor 13 passes through the turbine 12 and is sent to a downstream side of the exhaust flow passage L2 from the turbine 12. When the turbine 12 is rotated by the exhaust gas, rotational power is generated.

A power generator (not shown) is connected to the shaft that couples the compressor 11 and the turbine 12 to each other. The rotational power that has been transmitted from the turbine 12 to the shaft is used by the power generator for power generation.

The air, which has been compressed by the compressor 11, is supplied to the combustor 13 through the intake flow passage L1, while ammonia is supplied in a liquid state as fuel to the combustor 13. Combustion is performed in the combustor 13 with use of ammonia as fuel. The exhaust gas generated in the combustor 13 is discharged to the exhaust flow passage L2.

Specifically, the combustor 13 includes a combustion chamber 13a and an injector 13b. In the combustion chamber 13a, ammonia that is fuel is combusted. The injector 13b injects ammonia that is fuel toward the inside of the combustion chamber 13a. The injector 13b includes an injection port 13b1. Ammonia is injected from the injection port 13b1. The injector 13b faces the combustion chamber 13a. Specifically, the injection port 13b1 of the injector 13b faces the combustion chamber 13a. The injector 13b is connected to the ammonia tank 14 via a flow passage L3 for ammonia. Ammonia is supplied in a liquid state from the ammonia tank 14 to the injector 13b.

Ammonia is stored in a liquid state in the ammonia tank 14. In the ammonia tank 14, ammonia is maintained in a liquid state at, for example, an atmospheric pressure and −33° C. As described above, the ammonia tank 14 is connected to the injector 13b of the combustor 13 via the flow passage L3 for ammonia. Ammonia flows in the liquid state through the flow passage L3. The pump 15 is provided on the downstream side of the ammonia tank 14 in the flow passage L3. The pump 15 sends ammonia supplied from the ammonia tank 14, to the downstream side.

The flow passage L3 branches into a first flow passage L3a and a second flow passage L3b at a branching portion P1 on the downstream side of the ammonia tank 14, and the first flow passage L3a and the second flow passage L3b join at a joining portion P2 on the upstream side of the injector 13b. As described above, the flow passage L3 includes the first flow passage L3a and the second flow passage L3b that join at the joining portion P2 on the upstream side of the injector 13b. Ammonia that has passed through the pump 15 is sent to each of the first flow passage L3a and the second flow passage L3b at the branching portion P1.

In the combustion system 1, the temperature controller 100 for adjusting a temperature of ammonia to be supplied to the injector 13b is provided. The temperature controller 100 includes a flow ratio controller 110 and a preheater 120. As described later, the flow ratio controller 110 adjusts a flow ratio that is a ratio between a flow rate of the ammonia flowing into the joining portion P2 from the first flow passage L3a and a flow rate of the ammonia flowing into the joining portion P2 from the second flow passage L3b. As described later, the preheater 120 can cause the temperature of the ammonia flowing into the joining portion P2 from the first flow passage L3a and the temperature of the ammonia flowing into the joining portion P2 from the second flow passage L3b to be different from each other. Thus, the flow ratio controller 110 and the preheater 120 implement a function of adjusting the temperature of the ammonia to be supplied to the injector 13b.

The flow ratio controller 110 includes a first flow rate control valve 111 and a second flow rate control valve 112.

The first flow rate control valve 111 is provided in the first flow passage L3a. The first flow rate control valve 111 adjusts a flow rate of ammonia that passes through the first flow rate control valve 111 to flow into the joining portion P2 from the first flow passage L3a. For example, the flow rate of the ammonia flowing into the joining portion P2 from the first flow passage L3a is adjusted by adjusting an opening degree of the first flow rate control valve 111.

The second flow rate control valve 112 is provided in the second flow passage L3b. The second flow rate control valve 112 adjusts a flow rate of ammonia that passes through the second flow rate control valve 112 to flow into the joining portion P2 from the second flow passage L3b. For example, the flow rate of the ammonia flowing into the joining portion P2 from the second flow passage L3b is adjusted by adjusting an opening degree of the second flow rate control valve 112.

The preheater 120 preheats ammonia flowing through the second flow passage L3b. For example, the preheater 120 is provided on the downstream side of the second flow rate control valve 112 in the second flow passage L3b. The second flow passage L3b and a heat medium flow passage L4 each pass through the preheater 120. Through the heat medium flow passage L4, a heat medium having a temperature higher than the temperature of ammonia flowing through the second flow passage L3b flows. Examples of the heat medium flowing through the heat medium flow passage L4 include vapor generated in the combustion system 1, an exhaust gas generated in the combustion system 1, and sea water.

In the preheater 120, heat exchange is performed between the ammonia flowing through the second flow passage L3b and the heat medium flowing through the heat medium flow passage L4. In this manner, in the preheater 120, the ammonia flowing through the second flow passage L3b is preheated by the heat medium flowing through the heat medium flow passage L4.

As described above, the ammonia flowing through the second flow passage L3b is preheated by the preheater 120, and then flows into the joining portion P2. Meanwhile, the ammonia flowing through the first flow passage L3a flows into the joining portion P2 without being preheated. Accordingly, the temperature of the ammonia flowing into the joining portion P2 from the second flow passage L3b is higher than the temperature of the ammonia flowing into the joining portion P2 from the first flow passage L3a.

A first temperature sensor T1 is provided on the downstream side of the first flow rate control valve 111 in the first flow passage L3a. The first temperature sensor T1 detects the temperature of the ammonia flowing into the joining portion P2 from the first flow passage L3a. A second temperature sensor T2 is provided on the downstream side of the preheater 120 in the second flow passage L3b. The second temperature sensor T2 detects the temperature of the ammonia flowing into the joining portion P2 from the second flow passage L3b.

The controller 16 includes, for example, a processor 16a and a memory 16b. The processor 16a includes, for example, a central processing unit (CPU). The memory 16b includes, for example, a ROM having a program or the like stored therein, and a RAM serving as a work area. The function of the controller 16 is implemented by, for example, the processor 16a executing the program stored in the memory 16b.

The controller 16 controls the entire combustion system 1. For example, the controller 16 controls the temperature controller 100 to control the temperature of the ammonia to be supplied to the injector 13b. In the example of FIG. 1, the controller 16 controls the flow ratio controller 110 including the first flow rate control valve 111 and the second flow rate control valve 112 in the temperature controller 100, to control the temperature of the ammonia to be supplied to the injector 13b. Further, the controller 16 can acquire detection results from various sensors such as the first temperature sensor T1 and the second temperature sensor T2.

In the combustion system 1, the controller 16 controls the temperature controller 100 based on information regarding a pressure of ammonia in the injector 13b such that the temperature of the ammonia to be supplied to the injector 13b becomes equal to or lower than a saturation temperature of the ammonia in the injector 13b. In this manner, as described later, the efficiency of the combustion system 1 can be improved. In the following, as examples of processing performed by the controller 16, a first example, a second example, a third example, and a fourth example are described in order.

A pressure and a saturation temperature of ammonia in the injector 13b mean, for example, a pressure and a saturation temperature of ammonia at an upstream-side end portion in the injector 13b. However, the pressure and the saturation temperature of the ammonia in the injector 13b may be a pressure and a saturation temperature of ammonia at a position shifted from the upstream-side end portion in the injector 13b.

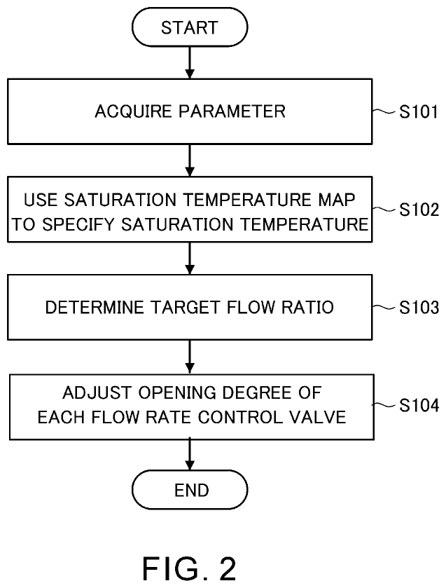

FIG. 2 is a flowchart for illustrating a first example of a flow of processing performed by the controller 16 in this embodiment. The processing flow illustrated in FIG. 2 is performed repeatedly, for example, at preset time intervals.

When the processing flow illustrated in FIG. 2 is started, in Step S101, the controller 16 acquires a parameter that affects the pressure of the ammonia in the injector 13b.

The saturation temperature that is a temperature at which liquid ammonia is vaporized is dependent on the pressure of ammonia. Specifically, as the pressure of ammonia becomes higher, the saturation temperature of ammonia becomes higher. As described later, in the first example of FIG. 2, the saturation temperature that is dependent on the pressure of ammonia is specified through use of the above-mentioned parameter.

The pressure of the ammonia in the injector 13b (specifically, the pressure of the ammonia at the upstream-side end portion in the injector 13b) corresponds to a value obtained by adding a pressure loss in the injector 13b to the pressure of the ammonia at the injection port 13b1 of the injector 13b. Accordingly, examples of the above-mentioned parameter may include various pieces of information to be used to estimate the pressure of the ammonia at the injection port 13b1 (for example, information on a pressure of the combustion chamber 13a, information on the number of revolutions of the turbine 12, information on an open/closed state of a bleed valve provided in the intake flow passage L1, and information on a discharge pressure of the compressor 11). Further, examples of the above-mentioned parameter may include various pieces of information to be used to estimate the pressure loss in the injector 13b (for example, information on a total flow rate of ammonia to be supplied to the injector 13b, and information on a power generation load).

In Step S101, the controller 16 may acquire the above-mentioned parameter based on an input operation performed by a user, may acquire the above-mentioned parameter from other controllers, or may acquire the above-mentioned parameter based on detection results obtained by various sensors.

Next, in Step S102, the controller 16 uses a saturation temperature map to specify the saturation temperature of the ammonia in the injector 13b.

The saturation temperature map is a map representing a correspondence relationship between the parameter acquired in Step S101 and the saturation temperature of the ammonia in the injector 13b. Specifically, in the saturation temperature map, the parameter acquired in Step S101 and the saturation temperature corresponding to the pressure of the ammonia in the injector 13b estimated from the parameter are associated with each other. The saturation temperature map is stored in advance in, for example, the memory 16b of the controller 16.

In Step S102, the controller 16 specifies the saturation temperature associated with the parameter acquired in Step S101 in the saturation temperature map, as the saturation temperature of the ammonia in the injector 13b.

For example, as the pressure of the combustion chamber 13a becomes higher, the pressure of the ammonia at the injection port 13b1 becomes higher, and hence the pressure of the ammonia in the injector 13b becomes higher. Accordingly, in the saturation temperature map, for example, the saturation temperature of the ammonia in the injector 13b is set to be higher as the pressure of the combustion chamber 13a becomes higher. Further, for example, as the total flow rate of ammonia to be supplied to the injector 13b becomes larger, the pressure loss in the injector 13b becomes larger, and hence the pressure of the ammonia in the injector 13b becomes higher. Accordingly, in the saturation temperature map, for example, the saturation temperature of the ammonia in the injector 13b is set to be higher as the total flow rate of the ammonia to be supplied to the injector 13b becomes larger. The saturation temperature map is, for example, a function in which, when parameters including the pressure of the combustion chamber 13a and the total flow rate of the ammonia to be supplied to the injector 13b are input, a saturation temperature corresponding to the input parameters is output. However, the parameters to be input are not limited to those examples.

Next, in Step S103, the controller 16 determines a target flow ratio that is a target value of a flow ratio that is a ratio between the flow rate of the ammonia flowing into the joining portion P2 from the first flow passage L3a and the flow rate of the ammonia flowing into the joining portion P2 from the second flow passage L3b.

In Step S103, the controller 16 determines, as the target flow ratio, for example, such a flow ratio that causes the temperature of the ammonia to be supplied to the injector 13b to become a temperature that is lower by a predetermined temperature (for example, from about several degrees Celsius to about several tens of degrees Celsius) than the saturation temperature specified in Step S102.

In the combustion system 1, the temperature of the ammonia flowing into the joining portion P2 from the first flow passage L3a and the temperature of the ammonia flowing into the joining portion P2 from the second flow passage L3b are each controlled to be constant. For example, the temperature of the ammonia flowing into the joining portion P2 from the second flow passage L3b is allowed to become constant by adjusting the flow rate of the heat medium flowing through the heat medium flow passage L4 depending on the flow rate of the ammonia flowing through the second flow passage L3b. Accordingly, the temperature of the ammonia to be supplied to the injector 13b can be changed by changing the above-mentioned flow ratio.

Each of the temperature of the ammonia flowing into the joining portion P2 from the first flow passage L3a and the temperature of the ammonia flowing into the joining portion P2 from the second flow passage L3b may be free of being controlled to become constant. In this case, the controller 16 determines the target flow ratio in consideration of the detection result obtained by the first temperature sensor T1 and the detection result obtained by the second temperature sensor T2.

Next, in Step S104, the controller 16 adjusts the opening degree of each flow rate control valve of the flow ratio controller 110 such that the flow ratio that is the ratio between the flow rate of the ammonia flowing into the joining portion P2 from the first flow passage L3a and the flow rate of the ammonia flowing into the joining portion P2 from the second flow passage L3b becomes the above-mentioned target flow ratio, and ends the processing flow illustrated in FIG. 2.

In Step S104, the controller 16 can control the above-mentioned flow ratio to the above-mentioned target flow ratio by adjusting the opening degree of the first flow rate control valve 111 and the opening degree of the second flow rate control valve 112. In this manner, the temperature of the ammonia to be supplied to the injector 13b becomes a temperature that is lower by the predetermined temperature (for example, from about several degrees Celsius to about several tens of degrees Celsius) than the saturation temperature specified in Step S102. Accordingly, while it is prevented that the temperature of the ammonia to be supplied to the injector 13b exceeds the saturation temperature, resulting in occurrence of vaporization of the ammonia, the temperature of the ammonia to be supplied to the injector 13b can be brought close to the saturation temperature.

In Step S104, the controller 16 controls the opening degree of the first flow rate control valve 111 and the opening degree of the second flow rate control valve 112 such that the total flow rate of the ammonia to be supplied to the injector 13b becomes a target value. In this manner, while the total flow rate of the ammonia to be supplied to the injector 13b is controlled to the target value, the above-mentioned flow ratio can be controlled to the above-mentioned target flow ratio.

As described above, the controller 16 of the combustion system 1 according to this embodiment controls the temperature controller 100 based on the information regarding the pressure of the ammonia in the injector 13b (in the above-mentioned example, the parameter that affects the pressure of the ammonia in the injector 13b) such that the temperature of the ammonia to be supplied to the injector 13b becomes equal to or lower than the saturation temperature of the ammonia in the injector 13b. In this manner, in consideration of the pressure of the ammonia in the injector 13b, the temperature of the ammonia to be supplied to the injector 13b can be adjusted to be equal to or lower than the saturation temperature of the ammonia in the injector 13b. Accordingly, while it is prevented that the temperature of the ammonia to be supplied to the injector 13b exceeds the saturation temperature, resulting in occurrence of vaporization of the ammonia, the temperature of the ammonia to be supplied to the injector 13b can be brought close to the saturation temperature. In this manner, it is possible to prevent an increase in the pressure loss due to an increase in a volume of ammonia along with partial vaporization of ammonia, and to prevent a vibration phenomenon caused along with a cycle of vaporization and recondensation of ammonia. Moreover, as compared to a case in which the temperature of the ammonia to be supplied to the injector 13b is excessively lower than the saturation temperature, energy to be consumed for combustion of ammonia in the combustor 13 can be reduced (for example, can be reduced by an amount corresponding to energy recovered by the preheater 120). Thus, while the vaporization of the ammonia is prevented, the efficiency of the combustion system 1 can be improved.

In particular, in the first example of FIG. 2, the information regarding the pressure of the ammonia in the injector 13b includes a parameter that affects the pressure of the ammonia in the injector 13b. The controller 16 uses a map representing a correspondence relationship between the above-mentioned parameter and the saturation temperature of the ammonia in the injector 13b (in the above-mentioned example, the saturation temperature map) to specify the above-mentioned saturation temperature based on the above-mentioned parameter, and controls the temperature controller 100 (in the above-mentioned example, the flow ratio controller 110) based on the specification result of the saturation temperature described above. In this manner, in consideration of the pressure of the ammonia in the injector 13b, the temperature of the ammonia to be supplied to the injector 13b can be appropriately adjusted so as to be equal to or lower than the saturation temperature of the ammonia in the injector 13b. In particular, the temperature controller 100 is controlled through use of the above-mentioned map, and hence a process of calculating the pressure of the ammonia in the injector 13b can be omitted so that a calculation load is reduced.

In particular, in the combustion system 1 according to this embodiment, the flow passage L3 includes the first flow passage L3a and the second flow passage L3b that join at the joining portion P2 on the upstream side of the injector 13b. The temperature of the ammonia flowing into the joining portion P2 from the first flow passage L3a and the temperature of the ammonia flowing into the joining portion P2 from the second flow passage L3b are different from each other. The temperature controller 100 includes the flow ratio controller 110 for adjusting the flow ratio that is a ratio between the flow rate of the ammonia flowing into the joining portion P2 from the first flow passage L3a and the flow rate of the ammonia flowing into the joining portion P2 from the second flow passage L3b. In this manner, with the above-mentioned flow ratio being adjusted, the temperature of the ammonia to be supplied to the injector 13b can be appropriately adjusted. In particular, as compared to a case in which one of the first flow passage L3a or the second flow passage L3b is omitted as in a combustion system 1B according to a second modification example to be described later, the temperature of the ammonia to be supplied to the injector 13b can be rapidly changed.

In particular, in the combustion system 1 according to this embodiment, the temperature controller 100 includes the preheater (in the above-mentioned example, the preheater 120) for preheating the ammonia flowing through one of the first flow passage L3a or the second flow passage L3b. In this manner, the temperature of the ammonia flowing into the joining portion P2 from the first flow passage L3a and the temperature of the ammonia flowing into the joining portion P2 from the second flow passage L3b can be appropriately brought different from each other.

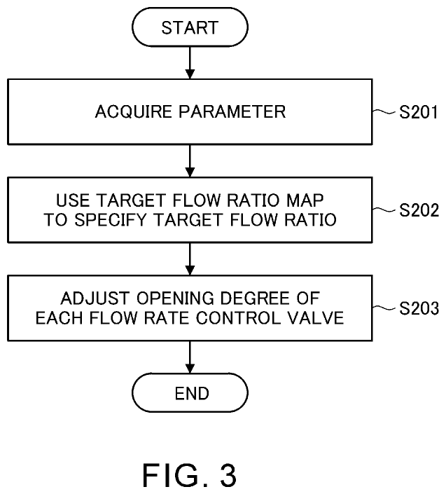

FIG. 3 is a flowchart for illustrating a second example of a flow of processing performed by the controller 16 in this embodiment. The processing flow illustrated in FIG. 3 is performed repeatedly, for example, at preset time intervals.

When the processing flow illustrated in FIG. 3 is started, in Step S201, the controller 16 acquires a parameter that affects the pressure of the ammonia in the injector 13b. The process step of Step S201 is similar to that of Step S101 described above.

Next, in Step S202, the controller 16 uses a target flow ratio map to specify a target flow ratio that is a target value of a flow ratio that is a ratio between the flow rate of the ammonia flowing into the joining portion P2 from the first flow passage L3a and the flow rate of the ammonia flowing into the joining portion P2 from the second flow passage L3b.

The target flow ratio map is a map representing a correspondence relationship between the parameter acquired in Step S201 and the target flow ratio. Specifically, in the target flow ratio map, the parameter acquired in Step S201 and such a flow ratio that causes the temperature of the ammonia to be supplied to the injector 13b to become a temperature that is lower by a predetermined temperature (for example, from about several degrees Celsius to about several tens of degrees Celsius) than the saturation temperature corresponding to the pressure of the ammonia in the injector 13b estimated from the parameter are associated with each other. The target flow ratio map is stored in advance in, for example, the memory 16b of the controller 16.

In Step S202, the controller 16 specifies the flow ratio associated with the parameter acquired in Step S201 in the target flow ratio map as the target flow ratio.

For example, as the pressure of the combustion chamber 13a becomes higher, the pressure of the ammonia at the injection port 13b1 becomes higher, and hence the pressure of the ammonia in the injector 13b becomes higher, and the saturation temperature of the ammonia in the injector 13b becomes higher. Accordingly, in the target flow ratio map, the flow ratio is set such that, for example, as the pressure of the combustion chamber 13a becomes higher, the temperature of the ammonia to be supplied to the injector 13b becomes higher. Further, for example, as the total flow rate of the ammonia to be supplied to the injector 13b becomes larger, the pressure loss in the injector 13b becomes larger, and hence the pressure of the ammonia in the injector 13b becomes higher, and the saturation temperature of the ammonia in the injector 13b becomes higher. Accordingly, in the target flow ratio map, the flow ratio is set such that, for example, as the total flow rate of the ammonia to be supplied to the injector 13b becomes larger, the temperature of the ammonia to be supplied to the injector 13b becomes higher. The target flow ratio map is, for example, a function in which, when parameters including the pressure of the combustion chamber 13a and the total flow rate of the ammonia to be supplied to the injector 13b are input, a flow ratio corresponding to the input parameters is output. However, the parameters to be input are not limited to those examples.

When the temperature of the ammonia flowing into the joining portion P2 from the first flow passage L3a and the temperature of the ammonia flowing into the joining portion P2 from the second flow passage L3b are each controlled to be constant, the target flow ratio map is generated in consideration of each of the above-mentioned temperatures that are already known. Meanwhile, when the temperature of the ammonia flowing into the joining portion P2 from the first flow passage L3a and the temperature of the ammonia flowing into the joining portion P2 from the second flow passage L3b are each not controlled to be constant, in the target flow ratio map, the detection result obtained by the first temperature sensor T1 and the detection result obtained by the second temperature sensor T2 are additionally set as the parameters to be input.

Next, in Step S203, the controller 16 adjusts the opening degree of each flow rate control valve of the flow ratio controller 110 such that the flow ratio that is a ratio between the flow rate of the ammonia flowing into the joining portion P2 from the first flow passage L3a and the flow rate of the ammonia flowing into the joining portion P2 from the second flow passage L3b becomes the above-mentioned target flow ratio, and ends the processing flow illustrated in FIG. 3. The process step of Step S203 is similar to that of Step S104 of FIG. 2 described above.

In the second example of FIG. 3, similarly to the first example of FIG. 2 described above, the controller 16 controls the temperature controller 100 based on the information regarding the pressure of the ammonia in the injector 13b (in the above-mentioned example, the parameter that affects the pressure of the ammonia in the injector 13b) such that the temperature of the ammonia to be supplied to the injector 13b becomes equal to or lower than the saturation temperature of the ammonia in the injector 13b. In this manner, similarly to the first example of FIG. 2 described above, the efficiency of the combustion system 1 can be improved.

In particular, in the second example of FIG. 3, the information regarding the pressure of the ammonia in the injector 13b includes a parameter that affects the pressure of the ammonia in the injector 13b. The controller 16 uses the map (in the above-mentioned example, the target flow ratio map) representing the correspondence relationship between the above-mentioned parameter and the control target of the temperature controller 100 (in the above-mentioned example, the target flow ratio) to specify the above-mentioned control target based on the above-mentioned parameter, and controls the temperature controller 100 (in the above-mentioned example, the flow ratio controller 110) based on the specification result of the above-mentioned control target. In this manner, in consideration of the pressure of the ammonia in the injector 13b, the temperature of the ammonia to be supplied to the injector 13b can be appropriately adjusted to become equal to or lower than the saturation temperature of the ammonia in the injector 13b. In particular, the temperature controller 100 is controlled through use of the above-mentioned map, and hence the process of calculating the pressure of the ammonia in the injector 13b can be omitted so that a calculation load is reduced.

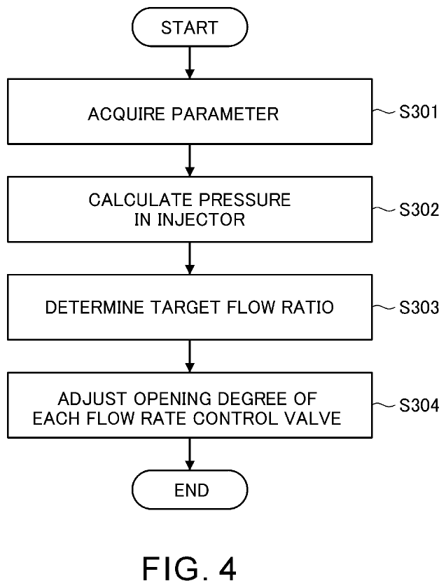

FIG. 4 is a flowchart for illustrating a third example of a flow of processing performed by the controller 16 in this embodiment. The processing flow illustrated in FIG. 4 is performed repeatedly, for example, at preset time intervals.

When the processing flow illustrated in FIG. 4 is started, in Step S301, the controller 16 acquires a parameter that affects the pressure of the ammonia in the injector 13b. The process step of Step S301 is similar to that of Step S101 described above.

Next, in Step S302, the controller 16 calculates the pressure of the ammonia in the injector 13b.

In Step S302, the controller 16 calculates the pressure of the ammonia in the injector 13b through use of the parameter acquired in Step S301. As described above, the pressure of the ammonia in the injector 13b (specifically, the pressure of the ammonia at the upstream-side end portion in the injector 13b) corresponds to a value obtained by adding a pressure loss in the injector 13b to the pressure of the ammonia at the injection port 13b1 of the injector 13b. For example, a pressure P10 of ammonia at the upstream-side end portion in the injector 13b is represented by the following expression (1) when a pressure of ammonia at the injection port 13b1 is represented by P20 and the above-mentioned pressure loss is represented by ΔP.

$$P 10 = P 20 + Δ P \qquad ( 1 )$$

In addition, the pressure loss ΔP is represented by, for example, the following expression (2) when a density of the ammonia is represented by ρ and a flow velocity of the ammonia is represented by U.

$$Δ P = ( ρ U \hat{} 2 ) / 2 \qquad ( 2 )$$

For example, the controller 16 calculates the pressure loss ΔP through use of the above-mentioned expression (2). The density ρ of ammonia is dependent on the temperature. Accordingly, the controller 16 may acquire information on the temperature of the ammonia at the upstream-side end portion in the injector 13b, and may change the density ρ in accordance with the information. However, the density ρ may be a fixed value. The controller 16 may specify the flow velocity U by, for example, detecting the flow velocity of the ammonia at the upstream-side end portion in the injector 13b by a sensor. A correction coefficient may be further added to the right side of the above-mentioned expression (2).

In addition, the controller 16 can calculate the pressure P10 of the ammonia at the upstream-side end portion in the injector 13b by, for example, substituting the pressure of the combustion chamber 13a into the above-mentioned expression (1) as the pressure P20 of the ammonia at the injection port 13b1 and substituting the pressure loss ΔP obtained by the above-mentioned expression (2) into the above-mentioned expression (1).

Next, in Step S303, the controller 16 determines the target flow ratio that is a target value of the flow ratio that is a ratio between the flow rate of the ammonia flowing into the joining portion P2 from the first flow passage L3a and the flow rate of the ammonia flowing into the joining portion P2 from the second flow passage L3b.

In Step S303, the controller 16 determines, as the target flow ratio, for example, such a flow ratio that causes the temperature of the ammonia to be supplied to the injector 13b to become a temperature that is lower by a predetermined temperature (for example, from about several degrees Celsius to about several tens of degrees Celsius) than the saturation temperature corresponding to the pressure of the ammonia in the injector 13b specified in Step S302.

Next, in Step S304, the controller 16 adjusts the opening degree of each flow rate control valve of the flow ratio controller 110 such that the flow ratio that is a ratio between the flow rate of the ammonia flowing into the joining portion P2 from the first flow passage L3a and the flow rate of the ammonia flowing into the joining portion P2 from the second flow passage L3b becomes the above-mentioned target flow ratio, and ends the processing flow illustrated in FIG. 4. The process step of Step S304 is similar to that of Step S104 of FIG. 2 described above.

In the third example of FIG. 4, similarly to the first example of FIG. 2 described above, the controller 16 controls the temperature controller 100 based on the information regarding the pressure of the ammonia in the injector 13b (in the above-mentioned example, the parameter that affects the pressure of the ammonia in the injector 13b) such that the temperature of the ammonia to be supplied to the injector 13b becomes equal to or lower than the saturation temperature of the ammonia in the injector 13b. In this manner, similarly to the first example of FIG. 2 described above, the efficiency of the combustion system 1 can be improved.

In particular, in the third example of FIG. 4, the information regarding the pressure of the ammonia in the injector 13b includes a parameter that affects the pressure of the ammonia in the injector 13b. The controller 16 calculates the above-mentioned pressure based on the above-mentioned parameter, and controls the temperature controller 100 (in the above-mentioned example, the flow ratio controller 110) based on the calculation result of the above-mentioned pressure. In this manner, in consideration of the pressure of the ammonia in the injector 13b, the temperature of the ammonia to be supplied to the injector 13b can be appropriately adjusted to become equal to or lower than the saturation temperature of the ammonia in the injector 13b. In particular, the pressure of the ammonia in the injector 13b is calculated based on the laws of physics, and hence the above-mentioned pressure can be more accurately specified.

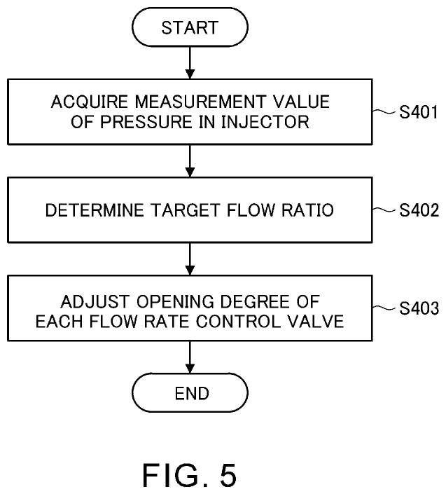

FIG. 5 is a flowchart for illustrating a fourth example of a flow of processing performed by the controller 16 in this embodiment. The processing flow illustrated in FIG. 5 is performed repeatedly, for example, at preset time intervals.

When the processing flow illustrated in FIG. 5 is started, in Step S401, the controller 16 acquires a measurement value of the pressure of the ammonia in the injector 13b.

In the fourth example, a sensor for measuring the pressure of the ammonia in the injector 13b is added to the combustion system 1. The controller 16 can acquire the measurement value of the above-mentioned pressure from such a sensor.

Next, in Step S402, the controller 16 determines the target flow ratio that is a target value of the flow ratio that is a ratio between the flow rate of the ammonia flowing into the joining portion P2 from the first flow passage L3a and the flow rate of the ammonia flowing into the joining portion P2 from the second flow passage L3b.

In Step S402, the controller 16 determines, as the target flow ratio, for example, such a flow ratio that causes the temperature of the ammonia to be supplied to the injector 13b to become a temperature that is lower by a predetermined temperature (for example, from about several degrees Celsius to about several tens of degrees Celsius) than the saturation temperature corresponding to the measurement value of the pressure of the ammonia in the injector 13b acquired in Step S401.

Next, in Step S403, the controller 16 adjusts the opening degree of each flow rate control valve of the flow ratio controller 110 such that the flow ratio that is a ratio between the flow rate of the ammonia flowing into the joining portion P2 from the first flow passage L3a and the flow rate of the ammonia flowing into the joining portion P2 from the second flow passage L3b becomes the above-mentioned target flow ratio, and ends the processing flow illustrated in FIG. 5. The process step of Step S403 is similar to that of Step S104 of FIG. 2 described above.

In the fourth example of FIG. 5, similarly to the first example of FIG. 2 described above, the controller 16 controls the temperature controller 100 based on the information regarding the pressure of the ammonia in the injector 13b (in the above-mentioned example, the measurement value of the pressure of the ammonia in the injector 13b) such that the temperature of the ammonia to be supplied to the injector 13b becomes equal to or lower than the saturation temperature of the ammonia in the injector 13b. In this manner, similarly to the first example of FIG. 2 described above, the efficiency of the combustion system 1 can be improved.

In particular, in the fourth example of FIG. 5, the information regarding the pressure of the ammonia in the injector 13b includes a measurement value of the pressure of the ammonia in the injector 13b. The controller 16 controls the temperature controller 100 (in the above-mentioned example, the flow ratio controller 110) based on the above-mentioned measurement value. In this manner, in consideration of the pressure of the ammonia in the injector 13b, the temperature of the ammonia to be supplied to the injector 13b can be appropriately adjusted to become equal to or lower than the saturation temperature of the ammonia in the injector 13b. In particular, the pressure of the ammonia in the injector 13b is directly detected, and hence the above-mentioned pressure can be more accurately specified.

The combustion system 1 according to this embodiment has been described above. However, various changes may be added to the above-mentioned examples.

For example, a flow rate control valve may be added to the upstream side of the branching portion P1 in the flow passage L3. In this case, for example, the total flow rate of the ammonia to be supplied to the injector 13b may be adjusted by the opening degree of the above-mentioned flow rate control valve, and the flow ratio that is a ratio between the flow rate of the ammonia flowing into the joining portion P2 from the first flow passage L3a and the flow rate of the ammonia flowing into the joining portion P2 from the second flow passage L3b may be adjusted by the opening degrees of the first flow rate control valve 111 and the second flow rate control valve 112.

For example, when the flow rate control valve is added to the upstream side of the branching portion P1 in the flow passage L3, a shutoff valve may be provided in the vicinity of this flow rate control valve. Further, a shutoff valve may be provided in the vicinity of the first flow rate control valve 111. In this case, through use of the shutoff valve, inflow of ammonia from the first flow passage L3a into the joining portion P2 can be rapidly stopped. Further, a shutoff valve may be provided in the vicinity of the second flow rate control valve 112. In this case, through use of the shutoff valve, inflow of ammonia from the second flow passage L3b into the joining portion P2 can be rapidly stopped.

For example, in the description above, the controller 16 controls the flow ratio controller 110 such that the flow ratio that is a ratio between the flow rate of the ammonia flowing into the joining portion P2 from the first flow passage L3a and the flow rate of the ammonia flowing into the joining portion P2 from the second flow passage L3b becomes the target flow ratio. However, the controller 16 may control the flow ratio controller 110 such that the measurement value of the temperature of the ammonia to be supplied to the injector 13b becomes a target temperature. In this manner, the temperature of the ammonia to be supplied to the injector 13b can be more accurately controlled. For example, when a temperature sensor is provided on the downstream of the joining portion P2 in the flow passage L3, the controller 16 can acquire the measurement value of the temperature of the ammonia to be supplied to the injector 13b, based on the detection result obtained by the temperature sensor. Further, for example, the controller 16 uses, as the above-mentioned target temperature, a temperature that is lower by a predetermined temperature (for example, from about several degrees Celsius to about several tens of degrees Celsius) than the saturation temperature of the ammonia in the injector 13b.

For example, a mixer for mixing the ammonia may be added to the joining portion P2 in the flow passage L3. In this manner, the ammonia flowing into the joining portion P2 from the first flow passage L3a and the ammonia flowing into the joining portion P2 from the second flow passage L3b are mixed by the mixer, and hence unevenness of the temperature of the ammonia to be supplied to the injector 13b is prevented.

For example, in the above-mentioned example, one injector 13b that becomes a supply destination of ammonia is provided. However, a plurality of injectors 13b that become a supply destination of ammonia may be provided. In this case, one pair of the first flow passage L3a through which low-temperature ammonia is allowed to flow and the second flow passage L3b through which high-temperature ammonia is allowed to flow may be provided for each injector 13b, or only one pair as described above may be provided for all of the injectors 13b.

For example, in the above-mentioned example, one pair of the first flow passage L3a through which low-temperature ammonia is allowed to flow and the second flow passage L3b through which high-temperature ammonia is allowed to flow, is provided. However, the above-mentioned pair may be provided as a plurality of pairs. That is, a plurality of first flow passages L3a and a plurality of second flow passages L3b may be provided in the flow passage L3. In this case, the first flow rate control valve 111 of each first flow passage L3a and the second flow rate control valve 112 of each second flow passage L3b may each be replaced with a shutoff valve. In this case, with the open and closed states of each shutoff valve being switched, the temperature of the ammonia to be supplied to the injector 13b can be rapidly changed. Moreover, with the shutoff valve being used, equipment cost can be reduced.

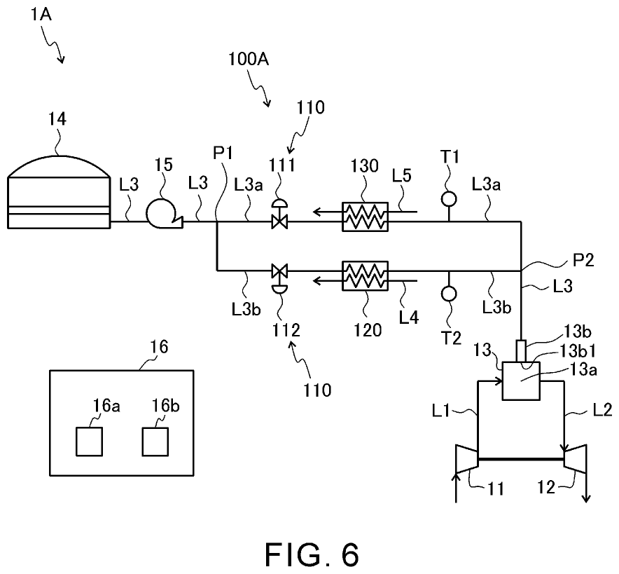

FIG. 6 is a schematic view for illustrating a configuration of a combustion system 1A according to a first modification example. As illustrated in FIG. 6, the combustion system 1A is different from the above-mentioned combustion system 1 in that a preheater 130 is added. A temperature controller 100A of the combustion system 1A further includes the preheater 130 in addition to the flow ratio controller 110 and the preheater 120.

The preheater 130 preheats the ammonia flowing through the first flow passage L3a. For example, the preheater 130 is provided on the downstream side of the first flow rate control valve 111 in the first flow passage L3a. The first flow passage L3a and a heat medium flow passage L5 each pass through the preheater 130. Through the heat medium flow passage L5, a heat medium having a temperature higher than the temperature of ammonia flowing through the first flow passage L3a flows. Examples of the heat medium flowing through the heat medium flow passage L5 include, similarly to the heat medium flowing through the heat medium flow passage L4, vapor generated in the combustion system 1A, an exhaust gas generated in the combustion system 1A, and sea water.

In the preheater 130, heat exchange is performed between the ammonia flowing through the first flow passage L3a and the heat medium flowing through the heat medium flow passage L5. In this manner, in the preheater 130, the ammonia flowing through the first flow passage L3a is preheated by the heat medium flowing through the heat medium flow passage L5. In the combustion system 1A, the first temperature sensor T1 is provided on the downstream side of the preheater 130 in the first flow passage L3a.

In the combustion system 1A, the ammonia flowing through the first flow passage L3a is preheated by the preheater 130, and then flows into the joining portion P2. However, the thermal energy added to the ammonia in the preheater 130 is smaller than the thermal energy added to the ammonia in the preheater 120. Accordingly, the temperature of the ammonia flowing into the joining portion P2 from the second flow passage L3b is higher than the temperature of the ammonia flowing into the joining portion P2 from the first flow passage L3a.

As described above, in the combustion system 1A according to the first modification example, the temperature controller 100A includes a first preheater (in the above-mentioned example, the preheater 130) for preheating the ammonia flowing through the first flow passage L3a and a second preheater (in the above-mentioned example, the preheater 120) for preheating the ammonia flowing through the second flow passage L3b. In this manner, the temperature of the ammonia flowing into the joining portion P2 from the first flow passage L3a can be adjusted through use of the first preheater. For example, the temperature of the ammonia flowing into the joining portion P2 from the first flow passage L3a can be adjusted by adjusting the temperature, the flow rate, or the like of the heat medium flowing through the heat medium flow passage L5. Accordingly, the controllability of the temperature of the ammonia to be supplied to the injector 13b is more improved.

In the combustion system 1A, similarly to the above-mentioned combustion system 1, the controller 16 controls the temperature controller 100 based on the information regarding the pressure of the ammonia in the injector 13b such that the temperature of the ammonia to be supplied to the injector 13b becomes equal to or lower than the saturation temperature of the ammonia in the injector 13b. For example, in the combustion system 1A, the processing performed by the controller 16 may be similar to those in the first example, the second example, the third example, and the fourth example described above.

Further, various changes that may be added to the above-mentioned combustion system 1 may also be added to the combustion system 1A.

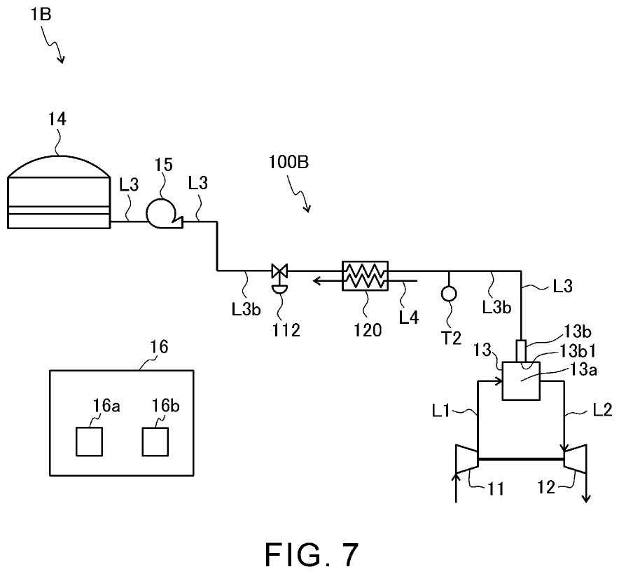

FIG. 7 is a schematic view for illustrating a configuration of a combustion system 1B according to a second modification example. As illustrated in FIG. 7, the combustion system 1B is different from the above-mentioned combustion system 1 in that the first flow passage L3a is omitted. A temperature controller 100B of the combustion system 1B includes the second flow rate control valve 112 and the preheater 120.

In the combustion system 1B, the flow passage L3 does not branch, and ammonia that has passed through the preheater 120 is directly sent to the injector 13b. The controller 16 can adjust the temperature of the ammonia sent from the preheater 120 to the injector 13b by adjusting, for example, the temperature, the flow rate, or the like of the heat medium flowing through the heat medium flow passage L4. That is, in the combustion system 1B, the temperature of the ammonia to be supplied to the injector 13b is adjusted through use of the preheater 120.

As described above, in the combustion system 1B according to the second modification example, the flow passage L3 includes no part that joins on the upstream side of the injector 13b, and the temperature controller 100B includes the preheater 120 for preheating the ammonia flowing through the flow passage L3. In this manner, as compared to the combustion system 1 described above, the first flow passage L3a and a device provided in the first flow passage L3a are omitted, and hence equipment cost can be reduced. Moreover, the ammonia that has passed through the preheater 120 is directly sent to the injector 13b without being mixed with ammonia having a lower temperature, and hence the temperature of the ammonia that has passed through the preheater 120 can be further reduced. Accordingly, it is prevented that the temperature of the ammonia that has passed through the preheater 120 excessively increases, resulting in occurrence of vaporization of the ammonia.

In the combustion system 1B, similarly to the above-mentioned combustion system 1, the controller 16 controls the temperature controller 100 based on the information regarding the pressure of the ammonia in the injector 13b such that the temperature of the ammonia to be supplied to the injector 13b becomes equal to or lower than the saturation temperature of the ammonia in the injector 13b.

For example, in the combustion system 1B, as in the first example described above, the controller 16 may use a map representing a correspondence relationship between the parameter that affects the pressure of the ammonia in the injector 13b and the saturation temperature of the ammonia in the injector 13b to specify the above-mentioned saturation temperature based on the above-mentioned parameter, and may control the temperature controller 100B based on the specification result of the above-mentioned saturation temperature. In this case, the controller 16 controls the temperature, the flow rate, or the like of the heat medium flowing through the heat medium flow passage L4 such that, for example, the temperature of the ammonia sent from the preheater 120 to the injector 13b becomes a temperature that is lower by a predetermined temperature (for example, from about several degrees Celsius to about several tens of degrees Celsius) than the specified saturation temperature.

For example, in the combustion system 1B, as in the second example described above, the controller 16 may use a map representing a correspondence relationship between the parameter that affects the pressure of the ammonia in the injector 13b and a control target (for example, a target value of the temperature, the flow rate, or the like of the heat medium flowing through the heat medium flow passage L4) of the temperature controller 100B to specify the above-mentioned control target based on the above-mentioned parameter, and may control the temperature controller 100B based on the specification result of the above-mentioned control target. In this case, the controller 16 specifies, for example, through use of the above-mentioned map, such a control target that causes the temperature of the ammonia sent from the preheater 120 to the injector 13b to become a temperature that is lower by a predetermined temperature (for example, from about several degrees Celsius to about several tens of degrees Celsius) than the saturation temperature. In addition, the controller 16 controls the temperature controller 100B such that the temperature, the flow rate, or the like of the heat medium flowing through the heat medium flow passage L4 becomes such a control target.

For example, in the combustion system 1B, as in the third example described above, the controller 16 may calculate the above-mentioned pressure based on the parameter that affects the pressure of the ammonia in the injector 13b, and may control the temperature controller 100B based on the calculation result of the above-mentioned pressure. In this case, the controller 16 controls the temperature, the flow rate, or the like of the heat medium flowing through the heat medium flow passage L4 such that, for example, the temperature of the ammonia sent from the preheater 120 to the injector 13b becomes a temperature that is lower by a predetermined temperature (for example, from about several degrees Celsius to about several tens of degrees Celsius) than the saturation temperature corresponding to the above-mentioned pressure.

For example, in the combustion system 1B, as in the fourth example described above, the controller 16 may control the temperature controller 100B based on the measurement value of the pressure of the ammonia in the injector 13b. In this case, the controller 16 controls the temperature, the flow rate, or the like of the heat medium flowing through the heat medium flow passage L4 such that, for example, the temperature of the ammonia sent from the preheater 120 to the injector 13b becomes a temperature that is lower by a predetermined temperature (for example, from about several degrees Celsius to about several tens of degrees Celsius) than the saturation temperature corresponding to the measurement value of the above-mentioned pressure.

Further, various changes that may be added to the above-mentioned combustion system 1 may also be added to the combustion system 1B.

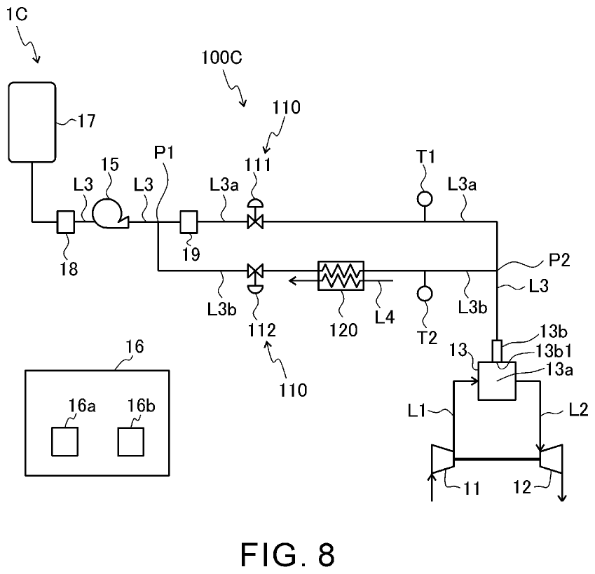

FIG. 8 is a schematic view for illustrating a configuration of a combustion system 1C according to a third modification example. As illustrated in FIG. 8, the combustion system 1C is different from the above-mentioned combustion system 1 in that the ammonia tank 14 is replaced with a pressure-type ammonia tank 17. A temperature controller 100C of the combustion system 1C includes the flow ratio controller 110 and the preheater 120 similarly to the above-mentioned temperature controller 100.

In the ammonia tank 17, ammonia is stored in a liquid state. In the ammonia tank 17, unlike the above-mentioned ammonia tank 14, ammonia is maintained in the liquid state at a pressure higher than an atmospheric pressure and a temperature around an outside temperature. The ammonia tank 17 is connected to the injector 13b of the combustor 13 via the flow passage L3 for ammonia. The pump 15 is provided on the downstream side of the ammonia tank 17 in the flow passage L3.

The ammonia in the ammonia tank 17 is sent to the pump 15. In addition to occurrence of a pressure loss in a pipe from the ammonia tank 17 to the pump 15, with suction of the ammonia by the pump 15, the pressure of the ammonia at the inlet of the pump 15 becomes lower than the pressure of the ammonia in the ammonia tank 17. Accordingly, from the viewpoint of preventing occurrence of vaporization of ammonia sent to the pump 15, a sufficient head pressure may be secured by increasing the height in the vertical direction of the installing position of the ammonia tank 17 as much as possible.

A cooler 18 is provided on the downstream side of the ammonia tank 17 and the upstream side of the pump 15 in the flow passage L3. The cooler 18 cools the ammonia flowing on the downstream side of the ammonia tank 17 and the upstream side of the pump 15 in the flow passage L3. The cooler 18 is, for example, a heat pump. The cooler 18 may be a heat exchanger that uses part of ammonia extracted from the inside of the ammonia tank 17 and decompressed to be vaporized, as a refrigerant. In this case, the gas ammonia used as the refrigerant is sent to, for example, a denitration device or the like. With the ammonia flowing on the upstream side of the pump 15 in the flow passage L3 being cooled by the cooler 18, occurrence of vaporization of ammonia sent to the pump 15 can be prevented.

A cooler 19 is provided on the downstream side of the branching portion P1 and the upstream side of the first flow rate control valve 111 in the first flow passage L3a. The cooler 19 cools the ammonia flowing through the first flow passage L3a. The cooler 19 is, for example, a heat pump, similarly to the cooler 18. With the ammonia flowing through the first flow passage L3a being cooled by the cooler 19, under a condition in which the pressure of the ammonia in the injector 13b is low, occurrence of vaporization of ammonia in the injector 13b can be prevented.

However, both of the cooler 18 and the cooler 19 may be omitted from the combustion system 1C. One of the cooler 18 or the cooler 19 may be omitted from the combustion system 1C.

In the combustion system 1C, similarly to the above-mentioned combustion system 1, the controller 16 controls the temperature controller 100 based on the information regarding the pressure of the ammonia in the injector 13b such that the temperature of the ammonia to be supplied to the injector 13b becomes equal to or lower than the saturation temperature of the ammonia in the injector 13b. For example, in the combustion system 1C, the processing performed by the controller 16 may be similar to those in the first example, the second example, the third example, and the fourth example described above.

Further, various changes that may be added to the above-mentioned combustion system 1 may also be added to the combustion system 1C.

The above-mentioned combustion system 1C is an example in which the ammonia tank 14 is replaced with the pressure-type ammonia tank 17 in the above-mentioned combustion system 1. However, the ammonia tank 14 may be replaced with the pressure-type ammonia tank 17 in the above-mentioned combustion system 1A. The ammonia tank 14 may be replaced with the pressure-type ammonia tank 17 in the above-mentioned combustion system 1B.

The embodiment of the present disclosure has been described above with reference to the attached drawings, but, needless to say, the present disclosure is not limited to the above-mentioned embodiment. It is apparent that those skilled in the art may arrive at various alterations and modifications within the scope of claims, and those examples are construed as naturally falling within the technical scope of the present disclosure.

In the description above, the example has been described in which, in the combustion systems 1, 1A, 1B, and 1C, a rotational power generated by the turbine 12 is used for the purpose of driving a power generator. However, in the combustion systems 1, 1A, 1B, and 1C, the rotational power generated by the turbine 12 may be used for the purpose of, for example, driving a moving object such as a ship.

In the description above, the example has been described in which, in the combustion systems 1, 1A, 1B, and 1C, combustion energy in the combustor 13 is used for the purpose of rotating the turbine 12. However, in the combustion systems 1, 1A, 1B, and 1C, the combustion energy in the combustor 13 may be used for a purpose other than the purpose of rotating the turbine 12.

1. A combustion system, comprising:
an ammonia tank in which ammonia is allowed to be stored in a liquid state;
a combustor including:
a combustion chamber; and
an injector facing the combustion chamber, the injector being connected to the ammonia tank via a flow passage for the ammonia, the ammonia being allowed to be supplied in a liquid state to the injector;
a temperature controller that adjusts a temperature of the ammonia to be supplied to the injector; and
a controller that controls the temperature controller based on information regarding a pressure of the ammonia in the injector such that the temperature of the ammonia to be supplied to the injector becomes equal to or lower than a saturation temperature of the ammonia in the injector.

2. The combustion system according to claim 1,
wherein the flow passage includes a first flow passage and a second flow passage that join at a joining portion on an upstream side of the injector,
wherein a temperature of the ammonia flowing into the joining portion from the first flow passage and a temperature of the ammonia flowing into the joining portion from the second flow passage are different from each other, and
wherein the temperature controller includes a flow ratio controller that adjusts a flow ratio that is a ratio between a flow rate of the ammonia flowing into the joining portion from the first flow passage and a flow rate of the ammonia flowing into the joining portion from the second flow passage.

3. The combustion system according to claim 2, wherein the temperature controller includes a preheater that preheats the ammonia flowing through one of the first flow passage or the second flow passage.

4. The combustion system according to claim 2, wherein the temperature controller includes:
a first preheater that preheats the ammonia flowing through the first flow passage; and
a second preheater that preheats the ammonia flowing through the second flow passage.

5. The combustion system according to claim 1,
wherein the flow passage is free of part that joins on an upstream side of the injector, and
wherein the temperature controller includes a preheater that preheats the ammonia flowing through the flow passage.

6. The combustion system according to claim 1,
wherein the information includes a parameter that affects the pressure, and
wherein the controller uses a map representing a correspondence relationship between the parameter and the saturation temperature to specify the saturation temperature based on the parameter, and controls the temperature controller based on a specification result of the saturation temperature.

7. The combustion system according to claim 1,
wherein the information includes a parameter that affects the pressure, and
wherein the controller uses a map representing a correspondence relationship between the parameter and a control target of the temperature controller to specify the control target based on the parameter, and controls the temperature controller based on a specification result of the control target.

8. The combustion system according to claim 1,
wherein the information includes a parameter that affects the pressure, and
wherein the controller calculates the pressure based on the parameter, and controls the temperature controller based on a calculation result of the pressure.

9. The combustion system according to claim 1,
wherein the information includes a measurement value of the pressure, and
wherein the controller controls the temperature controller based on the measurement value.
